(19) United States
(12) Patent Application Publication
(10) Pub. No.: US 2009/0168594 A1
(43) Pub. Date: Jul. 2, 2009

(54) ACCESSORY SOCKET ASSEMBLY

(75) Inventors: Charles Thomas Stephenson, Tipp City, OH (US); Donald P. Kehoe, White Lake, MI (US)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(73) Assignee: Viking Range Corporation, Greenwood, MI (US)

(21) Appl. No.: 12/341,148

(22) Filed: Dec. 22, 2008

Related U.S. Application Data
(60) Provisional application No. 61/016,978, filed on Dec. 27, 2007.

(51) Int. Cl. B01F 7/00; B23P 19/04

(52) U.S. Cl. 366/331; 29/700

(57) ABSTRACT

An accessory socket assembly for a mixer is provided. The assembly includes an accessory shaft, with a threaded end and a non-threaded end and with at least a first pin therebetween, and an accessory socket, with a bore sized to receive the accessory shaft. The accessory socket has at least a first J-slot in the bore. The first J-slot including an upper wall and first and second pin retention walls, and being sized to receive the first pin of the accessory shaft when the shaft is inserted into the bore. Methods of inserting the accessory shaft into the accessory socket, and attaching an accessory are also provided.

### CROSS-REFERENCE TO RELATED APPLICATION

This application claims benefit of U.S. Provisional Application No. 61/016,978, filed Dec. 27, 2007, which is hereby incorporated by reference in its entirety.

### BACKGROUND

Mixers for kitchen use, sometimes called stand mixers, generally operate by rotating a beater, whip, or other accessory to combine foods together. Although they typically accommodate exchange of accessories to be rotated, known stand mixers often fail to provide sufficiently secure accessory attachment and retention. Since the accessories are rotated at high speeds, secure retention of the accessory on the stand mixer is necessary to prevent the accessory from falling out, or from galling the accessory socket, the accessory shaft, or both, which can result in welding or seizing of the accessory shaft to the accessory socket and/or which can render the accessory and thus the mixer ineffective to perform its main objective, i.e. mixing ingredients in a bowl.

### SUMMARY

An accessory socket assembly that can be used with a mixing apparatus, such as a stand mixer, is provided. In one embodiment, the accessory socket assembly includes an accessory socket with at least one pin receiving slot capable of receiving a pin of a threaded shaft, to which an accessory can be secured. The shaft can either include a single pin extending outwardly from the surface of the shaft, two pins extending outwardly from the surface (usually on opposite sides of the shaft), or a single pin 66 extending through the shaft with each end of the pin extending outward from opposite sides of the shaft. Other pin configurations would also work, such as three or more pins extending from the shaft, generally in an equally spaced array, or such as combination of any of these pin arrangements. A spring can be used to maintain pressure on the accessory shaft, such as to force it downward to keep the pin(s) secured within the corresponding slot(s) of the accessory socket. Together with the force of the spring, the shape of the receiving slot(s) of the accessory socket retains the pin(s) of the threaded shaft, with the pins being “pushed” by engagement with the walls of the slots to rotate the threaded shaft, and thus the accessory. The accessory socket assembly can lock or secure various accessories to the mixer, such as beaters, dough hooks, whips, and/or the like.

In one embodiment, an accessory socket assembly includes both an accessory shaft and an accessory socket. The accessory shaft includes a threaded end and a non-threaded end, and at least a first pin at a central portion between the threaded end and non-threaded end. The accessory socket includes a bore sized to receive the non-threaded end of the accessory shaft, with the bore having a first and a second end and being bounded by a peripheral wall of the socket. The accessory socket has at least a first J-slot in its peripheral wall. The first J-slot includes an upper wall and first and second pin retention walls, and is sized to receive the first pin of the accessory shaft when the shaft is inserted into the bore.

Optionally, the accessory shaft can include a second pin, and the accessory socket can include a second J-slot in its peripheral wall. The second J-slot is sized to receive the second pin of the accessory shaft when the shaft is inserted into the bore. Further, the first pin and the second pin can be on opposite sides of the accessory shaft, and the first J-slot and the second J-slot can be on opposite sides of the accessory socket. Optionally still, the first J-slot can be at a lower portion of the bore. The threaded end of the accessory shaft can be sized to receive an accessory, and the non-threaded end of the accessory shaft generally is inserted into the bore. Further, the mixer can be a stand mixer, and a spring can be included on the accessory shaft at the first end of the bore.

In another embodiment, a method is disclosed of inserting an accessory shaft into an accessory socket in a mixer. The accessory shaft has a threaded end and a non-threaded end, and has at least a first pin at a central portion between the threaded end and non-threaded end. The accessory socket includes a bore sized to receive the non-threaded end of the accessory shaft. The bore has a first and a second end and is bounded by a peripheral wall of the socket. The accessory socket has at least a first J-slot in the peripheral wall. The first J-slot includes an upper wall and first and second pin retention walls, and is sized to receive the first pin of the accessory shaft when the shaft is inserted into the bore. The method includes inserting the accessory shaft into the accessory socket, and rotating the accessory shaft into a locking position.

Optionally, the step of inserting the accessory shaft into the accessory socket includes inserting the first pin into the first J-slot. During insertion, the first pin is inserted into the J-slot until it intersects the upper wall, and the step of rotating the accessory socket into a locking position includes moving the first pin along the upper wall and then away from the upper wall to a position adjacent the first and second pin retention walls. In this position, the first pin intersects either (1) the first pin retention wall, (2) the second pin retention wall, or (3) both the first pin and second pin retention walls. Optionally still, a spring can be placed on the non-threaded end of the accessory shaft prior to insertion into the accessory socket, and the step of lowering the first pin away from the upper wall proceeds under force applied by the spring. The method further can include attaching an accessory to the threaded end of the shaft. Further, the accessory shaft can include a second pin, and the accessory socket can include a second J-slot, the second J-slot sized to receive the second pin of the accessory shaft when the shaft is inserted into the bore. Further still, the first pin and the second pin can be on opposite sides of the accessory shaft, and the first J-slot and the second J-slot can be on opposite sides of the accessory socket.

The foregoing and other features, aspects, and advantages of the invention will become more apparent upon review of the detailed description of the embodiments set forth below when taken in conjunction with the accompanying drawing figures, which are briefly described as follows.

### BRIEF DESCRIPTION OF THE DRAWINGS

According to common practice, the various features of the drawings discussed below are not necessarily drawn to scale. Dimensions of various features and elements in the drawings may be expanded or reduced to more clearly illustrate the embodiments of the invention.

FIG. 1 shows a side view of a prior art stand mixer.

FIG. 2 shows a prior art accessory socket.

FIG. 3 shows an exemplary threaded shaft.

FIG. 4 shows one embodiment of an accessory socket according to one aspect of the invention.

FIG. 5 shows a partial cut-away of a stand mixer accessory socket assembly with the accessory socket embodiment shown in FIG. 4.

FIG. 6 shows an embodiment of an accessory socket according to another aspect of the invention.

### DETAILED DESCRIPTION

For a more complete understanding of the present invention, reference should be made to the following detailed description and accompanying drawings, wherein like reference numerals, where appropriate, designate corresponding parts throughout the figures.

To facilitate understanding and explanation of the present invention, the elements and numerals described herein will utilize the terms “upper,” “lower,” “top,” “bottom,” “front,” and “back” to distinguish, for example, portions of the stand mixer, accessory socket, or accessory shaft. These conventions are included merely for ease of explanation and understanding of the description and should not be construed to be limiting in any manner. Designations such as “upper,” “lower,” etc., also can be “first,” “second,” etc.

According to common practice, the various features of the drawings discussed herein are not necessarily drawn to scale. Dimensions of various features and elements in the drawings may be expanded or reduced to illustrate more clearly the embodiments of the invention. The dimensions of the accessory socket assembly may also be altered, for example, to accommodate various attachments or other accessories.

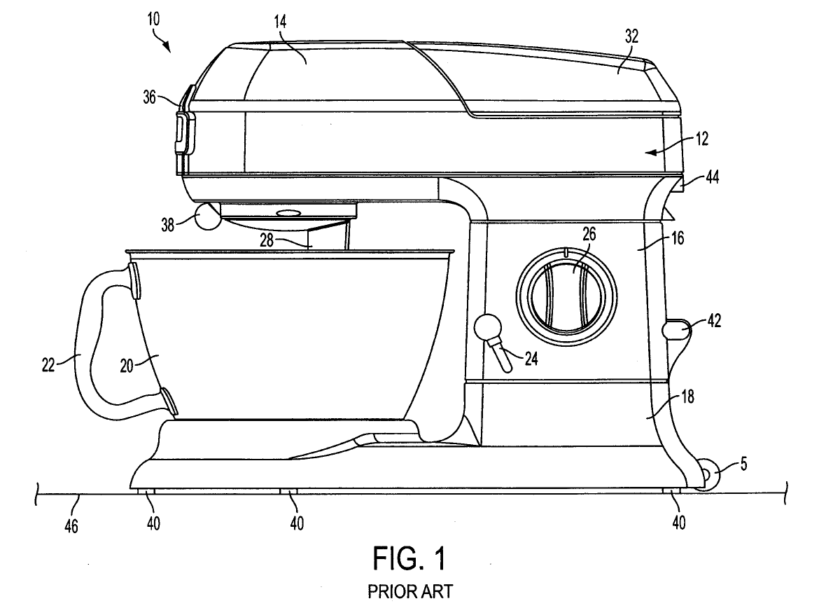

FIG. 1 shows a stand mixer 10 including a body 12, a head 14, a motor housing 16, and a base 18. The stand mixer 10 rests on a surface 46 as shown in FIG. 1. The base 18 can receive and secure a bowl 20 with a handle 22. Generally, the bowl 20 is attached to the base 18 by placing the bowl 20 into circular slots and turning the bowl 20, either clockwise or counterclockwise, to lock the bowl 20 to the base 18. When the bowl 20 is in the locked position, the handle 22 typically will protrude from the front of the stand mixer 10 at a point fairly centrally located on a midpoint axis of the stand mixer 10. Once locked, the handle 22 can be used to move the stand mixer into position as desired on surface 46. Stand mixer 10 is described in detail in commonly assigned U.S. Pat. No. 7,175,338, the entirety of which is hereby incorporated by reference.

The head 14 of the body 12 includes a top and a bottom portion and typically houses an accessory socket assembly 28 affixed to the bottom portion. The accessory socket assembly 28 is capable of receiving various attachments or accessories to facilitate mixing in the bowl 20. The attachments or accessories can include “V” beaters, whips, dough hooks, etc. The stand mixer 10 drives the accessory under the power of a motor (not shown) housed in motor housing 16, in the head 14, or otherwise appropriately located. The motor is capable of operating at several speeds, including low, intermediate, and high speeds. The speed of the motor is controlled by turning/rotating a power control knob 26 that typically is housed on the motor housing 16 of the body 12.

To facilitate accessory attachment to the accessory socket 28, the head 14 is capable of being pivoted upwardly or otherwise moved out of the mixing position. Although the head 14 can alternatively be lifted vertically above the bowl 20 or the bowl 20 could be lowered away from the head 14, the stand mixer 10 shown in FIG. 1 pivots the head 14 out of the bowl 20 about pivot mechanism 42, which is operated via release lever 24. With the head 14 pivoted up, the stand mixer 10 typically locks into a service position to allow access to accessory socket 28, the accessories, or the bowl 20.

The stand mixer 10 also can include a high-speed attachment outlet cover 32 that typically covers a high-speed attachment outlet, and a slow-speed attachment outlet cover 36 that typically covers a slow-speed attachment outlet. The slow-speed attachment outlet cover 36 can be detached from the head 14 of the body 12 by slow-speed attachment outlet cover release 38. The back of the stand mixer 10 also can include at least one louver 44 that allows for air intake thereby cooling the internal motor. The base 18 typically rests on feet 40 along the bottom of the base 18 to engage the surface 46 upon which the stand mixer 10 resides. The stand mixer 10 also can include at least one wheel 5. Typically, wheel(s) 5 will project slightly from the base 18 and will allow a user to pivot the stand mixer 10 from the feet 40 onto the wheel(s) 5 for movement into a desired position.

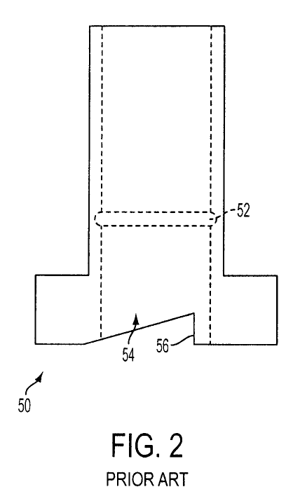

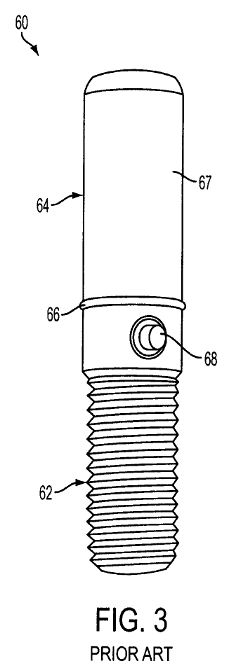

FIG. 2 shows a prior art accessory socket 50, which can be used in a stand mixer. The accessory socket 50 shown in FIG. 2 has a central bore 54 that includes an internal annular c-clip receiving slot or groove 52 within the bore 54 of the accessory socket 50. The c-clip receiving slot 52 receives a spring biased c-clip 66 (shown in FIG. 3) in a groove on the outer surface of an accessory shaft to hold the accessory shaft in the accessory socket. Projecting pin(s) 68 are shown below the c-clip shown in FIG. 3, and the pin(s) engage against shoulder(s) 56 of the accessory socket 50, to rotate or drive the accessory attached to the accessory shaft, under control of the motor. The pin can be a single pin extending from the shaft to be received in a single slot in socket 50, can be a single pin extending through the shaft with each end of the pin received into a slot in socket 50, or can be multiple pins extending from the shaft to be received into multiple slots in socket 50. The prior art design shown in FIG. 2 is prone to several attachment and retention problems. For example, the accessory socket 50 may inadequately retain an accessory shaft either because: (1) the bore 54 of accessory socket 50 is slightly oversized and fails to retain adequately the c-clip on the accessory shaft or in the c-clip receiving slot 52, (2) the accessory shaft is not fully pushed into accessory socket 50, resulting in failure of the c-clip to seat in the c-clip receiving slot 52 of the socket, or (3) the c-clip is deformed or missing. If any of these conditions occur, accessory socket 50 fails to retain the accessory shaft securely, which (1) causes the accessory shaft to become dislodged from a locked position or causes the accessory shaft to fail to lock into place, (2) galls the accessory socket or accessory shaft as a result of the socket spinning around the accessory shaft, effectively welding or seizing the accessory shaft into the accessory socket, and/or (3) fails to spin the accessory.

FIG. 3 shows an exemplary prior art threaded shaft 60 with a threaded end 62 for attaching an accessory and a non-threaded end 64. Typically, threaded end 62 is oriented in a downward direction and is secured to an accessory (not shown), e.g., a beater, whip, or dough hook. The non-threaded end 64 is inserted and received into an accessory socket, such as into bore 54 of accessory socket 50 shown in FIG. 2. As shown in FIG. 3, non-threaded end 64 includes radially projecting pin(s) 68, and can include two or more such pins as desired. Further, non-threaded end 64 of the threaded shaft 60 is shown generally smooth at surface 67, but can include occlusions, striations, or other profiles and features. As mentioned above, spring biased c-clip 66 is disposed in an annular slot formed in the surface of the non-threaded end and the c-clip snaps into the receiving slot 52 of accessory socket 50 when the non-threaded end is inserted into the socket.

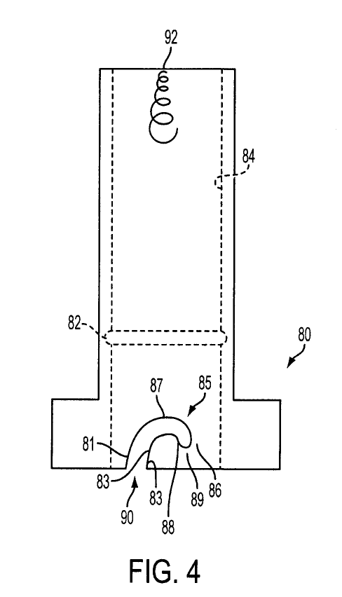

FIG. 4 shows an accessory socket 80 according to one aspect of the invention. Generally, accessory socket 80 is received in an accessory socket assembly of a mixer, such as in accessory socket assembly 28 of stand mixer 10 as shown in FIG. 1. Accessory socket 80 includes a cylindrical bore 84 that is sized to receive an accessory shaft, such as non-threaded end 64 of accessory shaft 60 shown in FIG. 3. The accessory socket 80 further includes a peripheral wall surrounding the bore and at least one angular J-slot 90, being matched in number to the pin(s) on the accessory shaft, formed in the wall at the lower end of the bore. As shown in FIG. 4, angular J-slot 90 is formed with side walls 81 and 83, upper wall 87, pin retention walls 86 and 88, and base wall 89. A coil spring 92 can be disposed at the upper end of the bore 84. Each angular J-slot forms an attachment feature 85 for socket 80.

In one exemplary method, to secure an accessory shaft 60 into accessory socket 80, non-threaded end 64 of shaft 60 is inserted into the bottom of the bore 84. Pin(s) 68 of accessory shaft 60 are received between the side walls 81, 83 of angular J-slot(s) 90. The accessory shaft 60 proceeds upward until pin(s) 68 engage(s) upper wall 87 of angular J-slot 90. At this point, the coil spring 92 (if provided in the bore 84 of socket 80) is compressed between the top end of the bore 84 and the top end of the accessory shaft 60. The accessory shaft 60 proceeds along wall 87 with the groove forcing the shaft 60 along its geometry. The accessory shaft 60 is rotated (clockwise in FIG. 4) until pin(s) 68 engage pin retention wall 86. The shaft 60 then moves downward to engage base wall 89, pin retention wall 86, and/or pin retention wall 88. Specifically, pin(s) 68 can be of a width to contact either pin retention wall 86, pin retention wall 88, both pin retention walls 86 and 88, and/or base wall 89. Generally, the pin(s) 68 will contact all three walls 86, 88, and 89 and will be held in such contact by spring 92. When accessory socket assembly 28 is rotated by the motor of the stand mixer, pin(s) 68 engage either engagement wall 86, engagement wall 88, or both, to rotate accessory shaft 60 and thus any accessory attached to threaded end 62 thereof.

Generally, threaded end 62 is screwed into a threaded receiving bore of an accessory, either directly or spaced by an additional securing or spacing means, such as a nut, washer, or other spacer.

In another exemplary method, the accessory shaft 60 can be removed from pin receiving slot(s) 90 once the stand mixer accessory socket assembly 28 is stopped from rotation. Such removal generally includes applying upward force to accessory shaft 60 to displace pin(s) 68 from their position between the pin retention walls 86 and 88 and base wall 89 (this can include displacing the spring 92 if provided in socket 80), rotating in a direction opposite the direction of insertion (counter-clockwise in FIG. 4, in the direction of wall 81), until the pin(s) 68 are free to follow the groove of the slot to move the shaft 60 downward to exit slot(s) 90 via side walls 81 and 83, which detaches the accessory shaft 60 and accessory from the accessory socket 80.

Although not necessary to secure shaft 60 within accessory socket 80, the non-threaded end 64 can also include a spring-biased c-clip 66 to provide an additional measure of secure capture of shaft 60 in accessory socket 80. Further, since several shafts, initially designed for prior art accessory sockets 50, include c-clips, these prior shafts can be used with the inventive accessory socket 80. Thus, as shown in FIG. 4, bore 84 may include a c-clip receiving slot or groove 82 around its interior wall to receive c-clip 66. In that event, a c-clip on an accessory shaft may snap into the groove 82 when the accessory shaft is seated to provide additional holding force. The groove 82 need not necessarily be included and, if not, a c-clip on an accessory shaft simply imparts some friction against the peripheral wall of the bore.

Although FIG. 4 shows spring 92 at an upper portion of bore 84, the spring 92 can be included in any workable position therealong, such as along or adjacent accessory socket 80, generally as long as the spring maintains downward pressure on the accessory shaft. For example, the spring can be twisted onto a pin in the top of the accessory socket (not shown) instead of screwed or attached to or over the top of the accessory shaft.

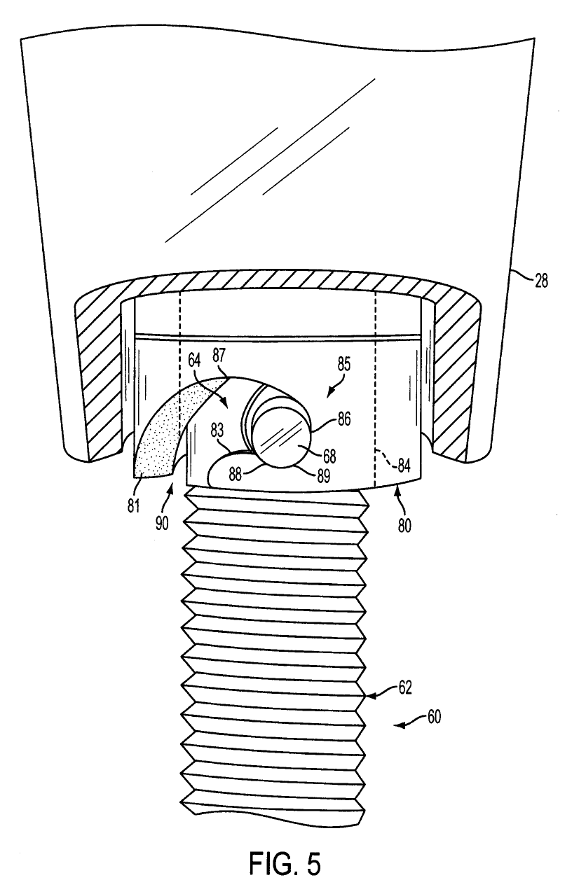

FIG. 5 shows a partial cut-away of a stand mixer accessory socket assembly 28 with the accessory socket embodiment shown in FIG. 4. As shown in FIG. 5, a pin 68 of accessory shaft 60 is inserted in J-slot 90 to secure the accessory shaft within socket 80. This cutaway view also shows the threaded bore 62 of the accessory shaft 60 to which an accessory can be attached.

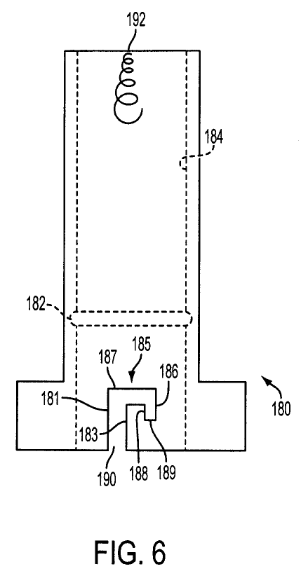

FIG. 6 shows an embodiment of an accessory socket according to another aspect of the invention. Generally, accessory socket 180 is received in an accessory socket assembly of a mixer, such as in accessory socket assembly 28 of stand mixer 10 as shown in FIG. 1. Accessory socket 180 includes a cylindrical bore 184 that is sized to receive an accessory shaft, such as non-threaded end 64 of accessory shaft 60 shown in FIG. 3. The accessory socket 180 further includes a peripheral wall surrounding the bore and at least one J-slot 190, being matched in number to the pin(s) on the accessory shaft, formed in the wall at the bottom of the bore. As shown in FIG. 6, J-slot 190 is formed with side walls 181 and 183, upper wall 187, pin retention walls 186 and 188, and base wall 189. A coil spring 192 can be disposed at the upper end of the bore 184. Each of the J-slots forms an attachment feature 185 of the socket 180.

In one exemplary method, to secure an accessory shaft 60 into accessory socket 180, non-threaded end 64 of shaft 60 is inserted into the bottom of the bore 184 of accessory socket 180. Pin(s) 68 of accessory shaft 60 are received between the side walls 181, 183 of J-slot(s) 190. The accessory shaft 60 proceeds upward until pin(s) 68 engage(s) upper wall 187 of J-slot 190. At this point, the coil spring 192 (if provided in the bore 184 of socket 180) is compressed between the top end of the bore 184 and the top end of the accessory shaft 60. The accessory shaft 60 is rotated until pin(s) 68 engage pin retention wall 186. The shaft 60 then moves downward to engage pin(s) 68 with base wall 189, pin retention wall 186, and/or pin retention wall 188. Specifically, pin(s) 68 can be of a width to contact either pin retention wall 186, pin retention wall 188, both pin retention walls 186 and 188, and/or base wall 189. When accessory socket assembly 28 is rotated by the motor of the stand mixer, pin(s) 68 engage either engagement wall 186, engagement wall 188, or both, to rotate accessory shaft 60 and thus any accessory attached to threaded end 62 thereof.

Generally, threaded end 62 is screwed into a threaded receiving bore of an accessory, either directly or spaced by an additional securing or spacing means, such as a nut, washer, or other spacer.

In another exemplary method, the accessory shaft 60 can be removed from the pin receiving slot(s) 190 once the stand mixer accessory socket assembly 28 is stopped from rotation. Such removal generally includes applying upward force to accessory shaft 60 to displace pin(s) 68 from their position between the pin retention walls 186 and 188 and base wall 189 (this can include displacing the spring 192 if provided in socket 180), rotating in a direction opposite the direction of insertion (counter-clockwise in FIG. 6, in the direction of wall 181), until the pin(s) 68 are free to follow the groove of the slot to move the shaft 60 downward to exit slot(s) 90 via side walls 181 and 183, which detaches the accessory shaft 60 and accessory form the accessory socket 180.

Although not necessary to secure shaft 60 within accessory socket 180, the non-threaded end 64 can also include a spring-biased c-clip 66 to provide an additional measure of secure capture of shaft 60 in accessory socket 180. Further, since several shafts, initially designed for prior art accessory sockets 50, include c-clips, these prior shafts can be used with the inventive accessory socket 180. Thus, as shown, bore 184 may include a c-clip receiving slot or groove 182 around its interior wall to receive c-clip 66. In that event, a c-clip on an accessory shaft may snap into the groove 182 when the accessory shaft is seated to provide additional holding force. The groove 182 need not necessarily be included and, if not, a c-clip on an accessory shaft simply imparts some friction against the peripheral wall of the bore.

Although FIG. 6 shows spring 192 at an upper portion of bore 184, the spring 192 can be included in any workable position therealong, such as along or adjacent accessory socket 180, generally as long as the spring maintains downward pressure on the accessory shaft. For example, the spring can be twisted onto a pin in the top of the accessory socket (not shown) instead of screwed or attached to or over the top of the accessory shaft.

According to common practice, the various features of the drawings discussed herein are not necessarily drawn to scale. Dimensions of various features and elements in the drawings may be expanded or reduced to illustrate more clearly the embodiments of the invention. The dimensions of the accessory socket may also be altered, for example, to accommodate various attachments or other accessories, to accommodate larger or smaller attachment shaft(s) or increased or shortened length shafts, or to accommodate mixer(s) or associated components of different dimensions in other configurations.

The invention has been described in terms of preferred configurations and methodologies considered by the inventors to be the best mode of carrying out the invention. These preferred embodiments are presented as examples only and should not be construed as limiting the scope of the invention. A wide variety of additions, deletions, and modifications to the illustrated and described embodiments might be made by those of skill in the art without departing from the spirit and scope of the invention.

What is claimed is:

1. An accessory socket assembly for a mixer, the assembly comprising:
an accessory shaft including a threaded end and a non-threaded end,
a first pin extending at a central portion between the threaded end and non-threaded end, the first pin having a first pin end;
an accessory socket including a bore sized to receive the accessory shaft, the bore having a first end and a second end;
the accessory socket having at least a first angular J-slot in a peripheral wall at the first end of the bore, the first J-slot including an upper wall and first and second pin retention walls between which the first pin end of the accessory shaft is received when inserted into the bore.

2. The accessory socket assembly of claim 1 wherein the accessory shaft further includes a second pin with a second pin end.

3. The accessory socket assembly of claim 2 wherein the accessory socket further includes a second angular J-slot, the second angular J-slot receiving the second pin end of the accessory shaft when the shaft is inserted into the bore.

4. The accessory socket assembly of claim 3 wherein the first pin and the second pin are on opposite sides of the accessory shaft.

5. The accessory socket assembly of claim 4 wherein the first angular J-slot and the second angular J-slot are on opposite sides of the accessory socket.

6. The accessory socket assembly of claim 1 wherein the first pin extends through the accessory shaft, with the first pin end extending from a first side of the shaft and a second pin end extending from a second side of the shaft.

7. The accessory socket assembly of claim 6 wherein the accessory socket further includes a second angular J-slot, the second angular J-slot receiving the second pin end when the shaft is inserted into the bore.

8. The accessory socket assembly of claim 1 wherein the threaded end of the accessory shaft is sized to receive an accessory and wherein the non-threaded end of the accessory shaft is inserted into the bore.

9. The accessory socket assembly of claim 1 wherein the mixer is a stand mixer.

10. The accessory socket assembly of claim 1 wherein a spring is disposed at the second end of the bore.

11. A method of inserting an accessory shaft into an accessory socket in a mixer, the method comprising:
providing the accessory shaft and the accessory socket, the accessory shaft including a threaded end and a non-threaded end, the shaft including at least a first pin at a central portion between the threaded end and non-threaded end, the accessory socket including a bore sized to receive the accessory shaft, the bore having a first end and a second end, the accessory socket having at least a first J-slot in a peripheral wall at the first end of the bore, the first J-slot including an upper wall and first and second pin retention walls;
inserting the accessory shaft into the accessory socket; and
rotating the accessory shaft into a locking position with the first pin received between the first and second pin retention walls.

12. The method of claim 11 wherein inserting the accessory shaft into the accessory socket includes inserting the first pin into the first J-slot.

13. The method of claim 12 wherein the first pin intersects the upper wall during insertion into the J-slot and removal therefrom.

14. The method of claim 13 wherein rotating the accessory socket into a locking position includes:
moving the first pin along the upper wall; and,
lowering the first pin away from the upper wall to a position adjacent the first and second pin retention walls.

15. The method of claim 14 wherein when the first pin is in the locking position, the first pin intersects either (1) the first pin retention wall, (2) the second pin retention wall, or (3) the first pin and second pin retention walls.

16. The method of claim 14 wherein a spring is included on the non-threaded end of the accessory shaft prior to insertion into the accessory socket, and wherein lowering the first pin away from the upper wall proceeds under force applied by the spring.

17. The method of claim 11 further comprising:
attaching an accessory to the threaded end of the shaft.

18. The method of claim 11 wherein the accessory shaft further includes a second pin.

19. The method of claim 18 wherein the accessory socket further includes a second J-slot, the second J-slot receiving the second pin of the accessory shaft when the shaft is inserted into the bore.

20. The method of claim 19 wherein the first pin and the second pin are on opposite sides of the accessory shaft.

21. The method of claim 20 wherein the first J-slot and the second J-slot are on opposite sides of the accessory socket.

22. A mixer comprising a mixer body carrying a rotatable accessory socket, the accessory socket including a generally cylindrical wall bounding an internal bore having an open end, and a slot formed in the cylindrical wall at the open end of the bore, the slot being sized and configured to receive and secure a pin of an accessory shaft when the accessory shaft is inserted into the open end of the bore and to impart rotary motion of the accessory socket to the accessory shaft through the pin.

23. The mixer of claim 22 and wherein the slot is a J-slot.

24. The mixer of claim 22 and further comprising a spring in the bore for retaining the pin within the slot.

25. The mixer of claim 22 and further comprising a generally annular groove in the cylindrical wall surrounding the bore for receiving a c-clip attached to an accessory shaft.

26. The mixer of claim 22 and comprising at least two slots in the cylindrical wall at the open end of the bore.

27. A method of inserting and seating an accessory shaft in a central bore of an accessory socket of a mixer, the method comprising:
moving the accessory shaft into an open end of the central bore;
rotating the accessory shaft a predetermined amount; and,
moving the accessory shaft back toward the open end of the accessory socket.

28. The method of claim 27 and wherein the accessory socket has a J-slot at the open end of the central bore and the accessory shaft has a radially projecting pin, the steps of claim 27 causing the pin to enter and seat within the J-slot.
